(19) United States
(12) Patent Application Publication
(10) Pub. No.: US 2001/0013018 A1
(43) Pub. Date: Aug. 9, 2001

(54) Card settlement system by debit card use

(76) Inventor: Koichi Awano, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(21) Appl. No.: 09/747,020

(22) Filed: Dec. 26, 2000

(30) Foreign Application Priority Data
Dec. 27, 1999 (JP) 11-370364
Jan. 19, 2000 (JP) 2000-10983

(51) Int. Cl. G06F 17/60

(52) U.S. Cl. 705/41; 705/43; 705/77; 235/381; 235/383

(57) ABSTRACT

In a card settlement system, a prepaid card is issued by using a debit card having a money withdrawal function at ATM installed in a settlement bank. When goods are purchased at a store by using the prepaid card, a price for the goods is transmitted from a store's bank in which the store has a store's account to the settlement bank as a settlement data. Money corresponding to the price for goods is remitted from the settlement bank to the store's account on the basis of the settlement data.

### BACKGROUND OF THE INVENTION

The present invention relates to a card settlement system by a debit card use. More particularly, according to the present invention, a user purchases a prepaid card by a debit card (a cash card) having cash withdrawal function. A price for goods purchased by using the prepaid card is settled between a bank having an account of a store in which the user purchased the goods and a bank with which the user has an account. Whereby a high security in an electronic commerce can be achieved in the card settlement system by the prepaid card use.

In conventional card settlement systems, there are known and spread a debit card system, a deferred payment credit card system, a prepaid card system and others. In case payment is made by such various cards, since the user is not required to previously prepare small money and wait for getting change, the payment can be quickly made.

Referring to FIG. 3 showing the conventional debit card system, when a user purchases goods, a debit card is inserted into a terminal unit 11 installed in a store 10 and then an identification number is inputted into the terminal unit. The identification number is identified by a banking organ C such as a bank or a post office by which the debit card is issued. When the identification is made, the price for the goods purchased by the user is remitted from a user's account of the user's settlement bank B (the debit card issuance banking organ or post office) to a store's account of a bank with which the store 10 in which the debit card is used has the account.

In the system such as the debit card system in which the identification numbers are used, since such a system is used over a wide area, there is a possibility that an identification number is stolen from a terminal unit and that another person makes improper use of the identification number over wide area before the user notes that the identification number was stolen. Such damages have actually occurred On the other hand, in the deferred payment credit card system, the identification is made by collation when a user purchases goods. Thereafter, the price for goods is withdrawn from the user's account of the user's bank.

In the credit card system, the ID for the card is copied and a forged card is made, as a result, expensive goods are purchased by another person before the user notes it and the user is charged the price for goods purchased by the another person. Such damages have numerously occurred.

Further, in the prepaid card system, a user buys a prepaid card by cash and then the user can purchase goods within amount of the prepaid card. There are a magnetic card type and IC card type in such prepaid cards.

In the IC card type prepaid card, in many cases a high amount is set as an amount capable of paying by the prepaid card. The IC card is designed to be able to reuse it. Therefore, the IC card can be rewritten and be readily forged. Further, it is possible to obtain an IC chip itself and to replace an IC chip attached to the card with another IC chip. Another person gets cash by the forged IC card as an example of damage when the IC card was stolen or lost. Such damages occur by a reason that the IC card itself has the same effect as money.

On the other hand, the magnetic card type prepaid cards can be made by a cheap cost and has an effect as throwaway cards capable of belonging to many and unspecified persons. However, in the magnetic type prepaid card, data therein can be readily copied like a tape recorder so that forgery or debasement is readily made to generate large damages as well known. Another person gets cash by the forged magnetic card as an example of damage when the card was stolen or lost.

As mentioned above, in all the conventional systems, a same sort of card can be used for purchasing goods in any terminal units over wide area without satisfactory security, as a result, many damages have occurred and damages have been spread.

### SUMMARY OF THE INVENTION

The present invention is made for solving the above problems. An object of the present invention is to provide a card settlement system by debit card use in which a card to be directly used for purchasing goods is not a debit card but a scattering and throwaway type prepaid card purchased by using the debit card to separate from the debit card. When the prepaid card is purchased, it is verified and confirmed at a debit card settlement bank side as to whether or not the debit card is a stolen or false card. By doing so, an unfair usage of the debit card is prevented.

An another object of the present invention is to provide a card settlement system by debit card use in which issuance of the prepaid card is permitted only at places or machines capable of drawing his or her money from his or her bank or a post office by using his or her debit card with ATM or the like. Accordingly, it is possible to certainly prevent an identification number of the debit card from leaking out at a terminal unit utilized by a user. Further, the user who purchased a prepaid card is not required to input the user's identification number when the user purchases goods, as a result, the user can avoid troublesome when the user purchases goods to improve convenience for shopping.

A further object of the present invention is to provide a card settlement system by debit card use in which the prepaid card does not have an amount of money capable of paying by itself, but be given an available amount of money as credit grant information. Actual settlement of accounts is executed between a debit card settlement bank and a store in which a user purchased goods in the manner of data processing. If the prepaid card is lost or others, the user informs the prepaid card settlement bank of it or takes another procedure in the same manner as procedures to be taken at time when a cash card is lost and therefore actual damages can be reduced to a minimal amount.

In order to achieve the above objects, in the card settlement system by debit card use relating to the present invention, first a prepaid card is purchased by using a debit card having a function of withdrawing money. A price for goods purchased by using the prepaid card is settled by remitting the price from a prepaid card settlement bank from which the user purchased the prepaid card to a store's bank with which the store has an account, on the basis of a settlement data sent from the store's bank to the settlement bank. The card settlement system is connected and constructed to execute the above operation and function.

The present invention further includes the following additional features. The prepaid card does not store any amount of money. The prepaid card stores credit grant information which is information representative of scope of available amount in the prepaid card. When a price for goods is paid at a card available store by using the prepaid card in which the credit grant information is recorded, the prepaid card is set to a reader/writer terminal unit installed by the store. In the reader/writer terminal unit, amount information corresponding to the price is subtracted from the credit grant information and the subtracted amount information is recorded in the prepaid card. At the same time, the price data inputted in the reader/writer terminal unit is sent to the settlement bank through the store's account of the store's bank. If the prepaid card is lost or damaged, actual damage can be suppressed in minimal amount by taking the same procedure as that to be took when a cash card is lost.

Further, the present invention includes the following features in addition to the above features. In case the user wishes to get cash by the prepaid card storing the credit grant information or amount information, the prepaid card having a balance is inserted into an ATM installed by the settlement bank at which the prepaid card is purchased and then identification number is inputted. When the identification number is proper, cash can be withdrawn. When cash has been withdrawn by the prepaid card, the prepaid card is processed to be invalid.

### BRIEF DESCRIPTION OF DRAWINGS

FIG. 1 is a block diagram showing concept of an embodiment of a card settlement system of prepaid card use relating to the present invention.

FIG. 2 is a diagram for explaining a structural example of the prepaid card.

FIG. 3 is a block diagram showing a conventional settlement system by a debit card use.

FIG. 4 is a flow chart showing a prepaid card issuance operation of the ATM.

FIG. 5 is a flow chart showing an operation of the reader/writer terminal unit.

FIG. 6 is a flow chart showing a prepaid card cashing operation of the ATM.

### DETAILED DESCRIPTION OF THE INVENTION

The present invention is explained in detail according to the attached drawings hereinafter.

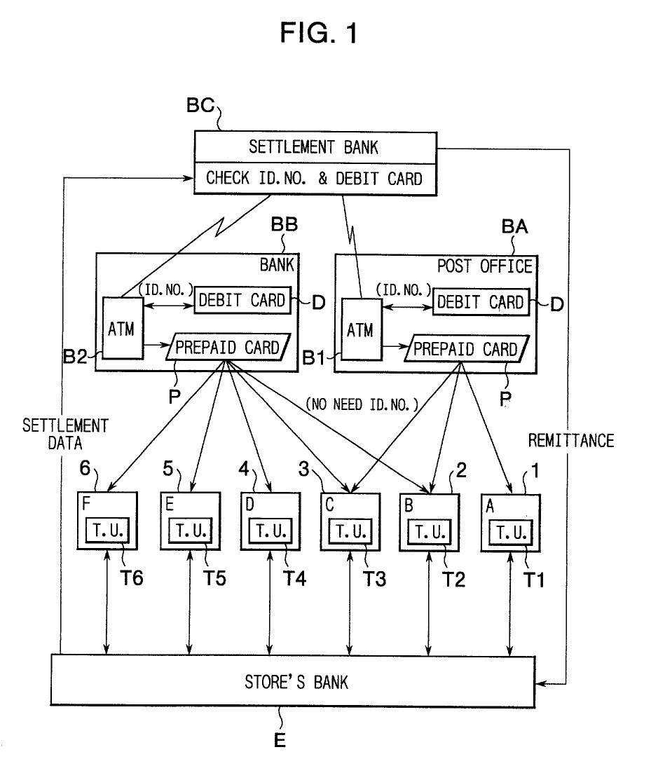

FIG. 1 is a block diagram showing an embodiment of a card settlement system of prepaid card use relating to the present invention. In FIG. 1, a reference symbol BA denotes a post office in which cash can be withdrawn by using a debit card D; B1 denotes a terminal unit such as ATM or the like installed in the post office BA; BB denotes a bank in which cash can be withdrawn by using a debit card D; B2 denotes a terminal unit such as ATM or the like installed in the bank BB; P denotes a prepaid card issued by the terminal unit B1 or B2; BC denotes a settlement bank which confirms and approves an identification number data transmitted from the terminal unit B1 or B2; 1, 2, 3 . . . . . . . . . n denote stores installing terminal units T1, T2, T3 . . . . . . Tn capable of using the prepaid card P; E denotes a bank with which the stores have accounts, respectively, to which data is transmitted from the terminal units T1, T2, T3 . . . . . . . . . Tn of the stores. Further, in this embodiment, since the debit card D and the ATM terminals B1 and B2 can have the same structure as conventional ones and the prepaid card issuance function can be relatively readily added to the ATM terminal, the explanation for them is omitted.

In the card settlement system formed as mentioned above, first the debit card D having a function capable of withdrawing cash is set to the terminal unit B1 or B2 installed in the post office BA or the bank BB. Thereafter, a user inputs an amount of money with which the prepaid card P is purchased.

Next, data necessary for collating such as the identification number of the debit card is transmitted from the terminal unit B1 or B2 to a computer in the settlement bank BC and then the data is collated or checked at the computer as to whether or not the debit card is a forgery or debasement card. In case the debit card is proper, the computer transmits a signal for approving the payment from user's account as to the amount of money and a signal for approving the issuance of a prepaid card P of the amount of money specified by the user to the terminal unit B1 or B2.

As a result, the terminal unit B1 or B2 issues the prepaid card of the amount specified by the user and transmits a card number for the prepaid card P to the computer of the settlement bank BC. The card number is stored in the computer. At the same time, the specified amount is withdrawn from the account of the debit card D and then transferred to a user's account for settlement by the prepaid card use.

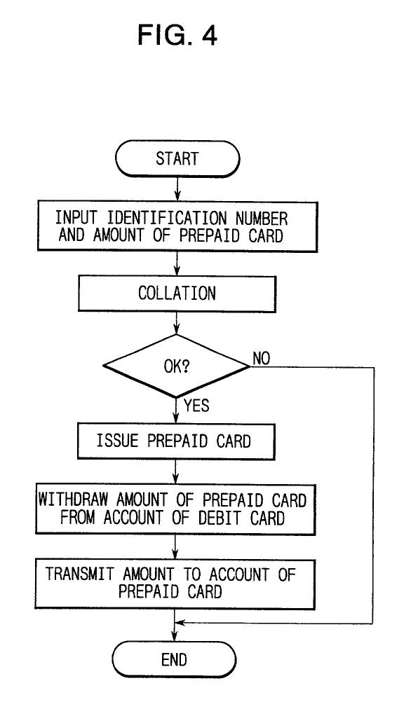

The above operation of the ATM is shown in FIG. 4 by a flow chart.

The user can buy goods and settle a price thereof at a store 1, 2, 3 . . . or n in which the prepaid card available terminal unit T1, T2, T3 . . . or Tn is installed, by using the prepaid card P purchased in the above-mentioned manner. The prepaid card can be used in the same manner as conventional prepaid card. In the case, it is not required to input the identification number of the debit card, since an input operation of the identification number of the debit card is troublesome and gives possibility of burglary.

When some goods are purchased at a store 1, 2, 3 . . . or n and the price of goods is settled by using the prepaid card P, the price data and the card data for the prepaid card P are transmitted from the terminal unit T1, T2, T3 . . . or Tn for the prepaid card installed in the store to a computer of the bank E with which the store has an account. The computer of the bank E transmits a settlement data including the price data and the card number to the settlement band BC for the debit card D. The settlement band BC confirms the card number of the prepaid card P as to whether or not the prepaid card P is a forgery or debasement card. If it is confirmed that the prepaid card is proper, the settlement amount corresponding to the price data is withdrawn from the settlement account for the prepaid card and then the settlement amount is transmitted to the account of the bank E requiring the settlement. When the above processing have been executed, a series of settlement procedures are finished. If the settlement bank ties up with a card issuance company, the settlement data is transmitted to the card issuance company and settled with the card issuance company. Thereafter, the settlement data is transmitted to the settlement bank BC. Further, the prepaid card terminal units T1, T2, T3 . . . Tn are constructed in the same structures as a conventional prepaid card terminal unit and the explanation thereof is omitted. In addition, the above description is explained as to the case that the prepaid card is used with store selling goods, but the prepaid card may be used for paying a charge for service offered by a store or a service industry.

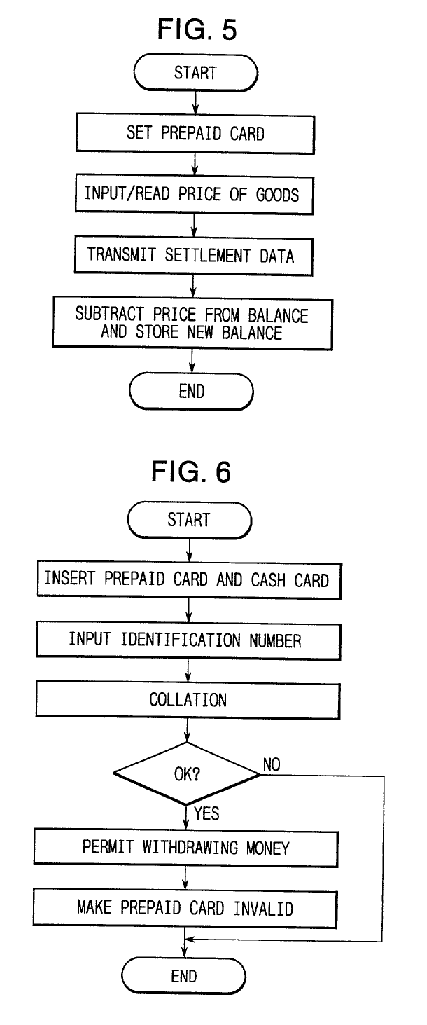

The operation of the reader/writer terminal unit is in FIG. 5 by a flow chart.

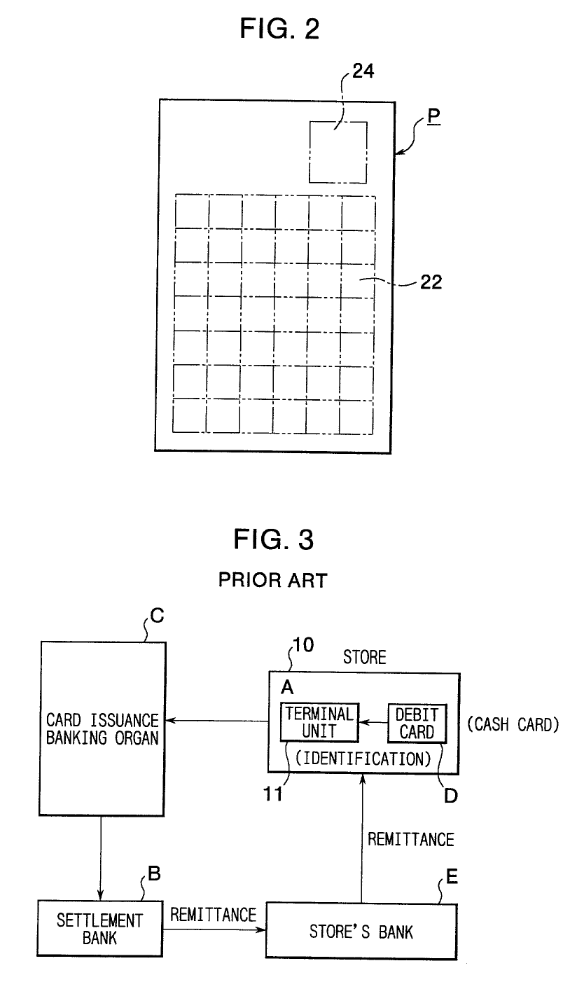

Conventional magnetic cards or IC cards may be adopted as prepaid cards, but it is desirable that capacitive cards as shown in FIG. 2 are adopted as prepaid cards, in order to prevent forgery or debasement of the prepaid cards. The capacitive card is called a fuse card.

In the prepaid card (hereinafter called fuse card) P, fuses are cut in accordance with a paid amount to store a rough amount. That is to say, the fuse card P includes a first memory area for storing a balance after payment of a price or a charge by using the prepaid card and a second memory area for storing rough amount of the balance. The fuse card previously stores a predetermined amount, for example, five thousand yen in a first memory area and in a second memory area.

The fuse card P includes capacitive memory area as the second memory area 24. In the capacitive memory area, data is memorized by state in which some of fuses are cut. The capacitive memory area includes, on one surface thereof, a plurality of first electrodes arranged in a row to correspond to arrangement of input/output terminal electrodes on a reader/writer and a second electrode having a longitudinal shape arranged in parallel to the row of the first electrodes. The first electrodes and the second electrode are connected by fuses, respectively. In case the fuses are not cut, electric current freely flows between the first electrodes and the second electrode through the fuses, respectively, since the fuses has a very small resistance value. In case a fuse is cut, the electric current flowing through the cut fuse is sharply reduced, since the cut fuse has very large resistance value.

In the above circuit of fuses and electrodes, a required voltage (12-16 volts) is applied to a fuse so that a large electric current flows through the fuse to cut off the fuse. As a result, the fuse becomes spent. Fuses which are not cut functions as unused closed circuits and one closed circuit gives one bit of digital data. Accordingly, the closed circuits are optionally formed to store a required amount data in the second memory area.

Further, the second memory area 24 may be not only a capacitive memory area but also an IC memory area accommodated in the fuse card P for electrically storing data, an magnetic memory area positioned in the card P or on the surface of the card P, or other memory means. Conventional memory means can be adopted as the second memory area 24. It is generally desirable to adopt the capacitive memory area in order to prevent the prepaid card from being forged or altered.

On the other hand, the first memory area 22 is magnetic tracks prepared in accordance with storage capacity. In the embodiment, the magnetic memory area constructing the first memory area 22 is formed by applying thermoplasticity thermal recording material to the prepaid card.

In the fuse card relating to the present invention, the rough amount omitting a fraction of the balance is stored in the second memory area 24, but not only an identification number or a personal information of the user but also data relating to a source of the debit card are not at all stored in the prepaid card.

Further, in the above embodiments in the present invention, the explanation is made about an example in which amount of money is stored in the prepaid card, but the present invention is not limited to the above embodiment. The prepaid card may store a credit grant information which is information representative of a scope of amount within which the user can use for payment of price or charge. In case the credit grant information is stored in the prepaid card, when the user uses the prepaid card for payment in a store, the prepaid card is set to a reader/writer unit installed in the store. The balance obtained by subtracting a purchase price to be paid in the store from the last balance stored in the prepaid card is recorded in the prepaid card as new credit grant information. The purchase price inputted in the reader/writer unit is transmitted to the settlement bank through the store's bank and then the purchase price is settled between the user's account and the store's account. If the prepaid card has been lost, an actual damage can be held at a minimum by taking the same procedures as that to be taken when a cash card has been lost.

Furthermore, in the prepaid card relating to the present invention, in case the user wishes to exchange for cash the prepaid card in which a balance of the credit grant information or amount information is recorded, the prepaid card as well as the debit card or cash card is inserted into the ATM installed in the bank at which the prepaid card is purchased. The bank may be another associated bank in which the debit card or cash card can be used. After the prepaid card and the debit card are inserted into the ATM, the user inputs his or her identification number in the ATM. When the identification number is proper, the prepaid card is exchanged into the cash and the user can withdraw money from the user's account. Thereafter, of course, the prepaid card is processed in invalid state. Such prepaid cards are improved not only in security thereof but also in utility and convenience thereof.

The above operation of the ATM is shown in FIG. 6 by a flow chart.

In the card settlement system by a debit card use relating to the present invention, as mentioned above, the prepaid card is purchased by using the debit card having the money withdrawal function. The price occurring by using the prepaid card is transmitted as a settlement data from the store's bank with which the store using the prepaid card has the account to the settlement band in which the prepaid card is purchased. The settlement bank transfers money of the price to the store's account on the basis of the settlement data. By doing so, the debit card is separated from the prepaid card to be used for purchasing goods. The prepaid card to be used at the end or the store is a disposable card which cannot be forged or altered. In the present invention, since the prepaid card is purchased by using the debit card, when the prepaid card is purchased, the debit card is collated through inputted identification number at the debit card settlement bank as to whether or not the debit card is a stolen or lost card, in order to ovoid an unjust use of the debit card. In the present invention, further, the prepaid card can be purchased only at terminal units like ATM capable of withdrawing money from the bank or the post office by using the debit card. Accordingly, the identification number of the debit card is not likely to be stolen for unjust use at such terminal units. A user purchasing the prepaid card is not required to input the identification number in the terminal unit when the user purchases goods at a store, as a result, not only the identification number is not likely to leak but also troublesome at chopping is reduced and the convenience of shopping is improved.

According to the other aspect of the present invention, the prepaid card does not store an amount of money as cash. The prepaid card stores credit grant information representative of a scope of amount of money available for purchasing goods. When the user purchases goods by using the prepaid card having the credit grant information, the price of the purchased goods is subtracted from the credit grant information or the balance thereof and the subtracted balance is stored in the prepaid card at the reader/writer terminal unit installed in the store in which the prepaid card is used. At the same time, the price inputted in the reader/writer terminal unit is transmitted to the settlement bank through the store's account of the bank with which the store has. Even if the prepaid card is lost, if the user takes the same procedures as that to be taken at when the cash card is lost, an actual damage can be suppressed to a minimum amount.

According to another aspect of the present invention, in case the user wish to change the credit grant information or the balance stored in the prepaid card into money, the prepaid card as well as the cash card or the debit card is inserted into the ATM installed in the settlement bank and then the identification number is inputted. If the inputted identification number is proper, it is possible to withdraw money corresponding to the balance. Thereafter, the prepaid card is processed to be in invalid. Accordingly, the prepaid card itself is improved in security, convenience of use thereof and others.

1. A card settlement system by a debit card use comprising:
means for issuing a prepaid card by using a debit card having a money withdrawal function;
means for transmitting a settlement data corresponding to a price or charge to be paid by using said prepaid card from a store's bank with which a prepaid card usable store has an account to a settlement bank in which said prepaid card is issued; and
means for remitting from said settlement bank to a store's account in said store's bank on the basis of said settlement data.

2. A card settlement system by a debit card use according to claim 1, wherein said prepaid card stores not an amount of money having a cash function but credit grant information indicative of a usable amount.

3. A card settlement system by a debit card use including a reader/writer unit installed in a store, said reader/writer unit comprising:
means for inputting or reading a settlement data to be paid to said store by using a prepaid card storing credit grant information;
means for storing a balance data obtained by subtracting said settlement data from said credit grant information or a balance previously obtained; and
means for transmitting said settlement data to a settlement bank through a store's bank with which said store has an account.

4. A card settlement system by a debit card use including an ATM of a settlement bank, said ATM comprising:
means for issuing a prepaid card by using a debit card having a money withdrawal function;
means for inserting a prepaid card having a balance and a cash card into said ATM;
means for inputting an identification number; and
means for permit withdrawing money when said identification number is proper and for making said prepaid card having the balance invalid.
